(19) United States
(12) Patent Application Publication
(10) Pub. No.: US 2021/0283695 A1
(43) Pub. Date: Sep. 16, 2021

(54) PCD DRILL AND MANUFACTURING METHOD FOR SAME

(71) Applicant: HONDA MOTOR CO., LTD., Minato-ku, Tokyo (JP)

(72) Inventors: Hiroyuki Fukushima, Hagagun, Tochigi-ken (JP); Junya Onose, Hagagun, Tochigi-ken (JP); Yuu Igarashi, Hagagun, Tochigi-ken (JP); Akihiro Osawa, Hagagun, Tochigi-ken (JP); Masaki Hosaka, Hagagun, Tochigi-ken (JP); Tomoya Kuroda, Hagagun, Tochigi-ken (JP)

(21) Appl. No.: 16/334,403

(22) PCT Filed: Sep. 20, 2017
(86) PCT No.: PCT/JP2017/033826

§ 371 Date: Mar. 19, 2019

(30) Foreign Application Priority Data
Sep. 20, 2016 (JP) 2016-183323

(51) Int. Cl. B23B 51/02

(52) U.S. Cl. CPC B23B 51/02; B23B 2226/315

(57) ABSTRACT

When forming a first preliminary flute on a PCD layer of a columnar body, electrical discharge machining is performed by setting the electrode orientation so that the first twist angle is α. Next, when forming a second preliminary flute on a substrate of the columnar body and a round bar, the grinding process is performed by setting the grinding orientation and direction for a diamond whetstone so that a second twist angle is larger than the first twist angle.

### TECHNICAL FIELD

The present invention relates to a PCD drill for performing cutting work and a manufacturing method for the PCD drill.

### BACKGROUND ART

One known type of drills used for cutting work (machining) is PCD drills having a tip that contains sintered diamond or polycrystalline diamond (PCD). This tip is made from a partial cut of a tip cutting tool, which is formed from a substrate made of cemented carbide and PCD disposed on the substrate. This tip is then joined to a body component, and cutting edges and thinning faces are further formed. Thereafter, flutes (cutting chip ejection grooves) are formed, thereby fabricating a body. The body component is made of cemented carbide, for example.

Flutes are typically formed by grinding work with a diamond grinding stone or by electrical discharge machining (see Japanese Laid-Open Patent Publication No. 2009-226539, for instance). Here, although grinding work can be done in a short time, it has a disadvantage in that it cannot be easily performed many times because the diamond grinding stone undergoes much wear when flutes are formed on PCD. Meanwhile, electrical discharge machining requires a long time for formation of flutes because it is lower in processing ability than grinding work.

For these reasons, it is conceivable to perform wire-cut electrical discharge machining when forming flutes on a tip cutting tool, and perform grinding work with a diamond grinding stone when forming flutes on the body component.

### SUMMARY OF INVENTION

When the working tool for forming flutes is changed between the tip side and the body component side as mentioned above, minute steps will be created in the flute. This leads to the risk of cutting chips being caught in the steps and failing to be ejected.

A main object of the present invention is to provide a PCD drill that can be fabricated efficiently.

Another object of the present invention is to provide a PCD drill that eliminates the risk of cutting chips failing to be ejected.

A further object of the present invention is to provide a manufacturing method for such PCD drills.

According to an embodiment of the present invention, a polycrystalline diamond (PCD) drill is provided, the polycrystalline diamond drill including a body component and a tip cutting tool formed from a substrate made of cemented carbide and a diamond layer disposed on the substrate, the tip cutting tool being set on a tip of the body component in a manner that the substrate faces the body component, thereby constituting a body. Both the diamond layer and the cemented carbide are configured to be exposed on rake faces and thinning faces formed on the tip cutting tool, and a first twist angle of the diamond layer is set smaller than a second twist angle of the substrate and the body component. Here, the “diamond layer” in the present invention shall include a layer composed only of diamond as well as a composite layer containing diamond and cemented carbide.

Using the configuration described above, creation of a step between the flute formed on the diamond layer and the flute formed on the substrate and the body component is prevented. Accordingly, cutting chips easily pass through the flutes. In other words, cutting chips are prevented from being caught in the flutes and stopping there. Thus, the risk of cutting chips failing to be ejected is eliminated.

Preferably, on the thinning faces, an extreme tip of each of flutes is located near a boundary between the diamond layer and the substrate. This gives the flutes relatively large opening area and cross-sectional area. Thus, it is further easier for cutting chips to pass through the flutes.

The body component may be composed of cemented carbide, for example, as with the substrate. This would have the advantage of facilitating the formation of flutes on the substrate and the body component.

According to another embodiment of the present invention, a manufacturing method for a polycrystalline diamond (PCD) drill including a body component and a tip cutting tool formed from a substrate made of cemented carbide and a diamond layer disposed on the substrate is provided. The manufacturing method includes: a process of joining a cylindrical member which will be made into the tip cutting tool to a tip of the body component in a manner that the substrate faces the body component side; a process of performing electrical discharge machining on the cylindrical member to form cutting edges and thinning faces and to expose both the diamond layer and the substrate on rake faces and the thinning faces; a process of performing electrical discharge machining on the diamond layer to form a first preliminary flute in a manner that the first preliminary flute is made at a first twist angle; and a process of applying grinding work to the body component and the substrate to form a second preliminary flute in a manner that the second preliminary flute adjoins the first preliminary flute and is made at a second twist angle larger than the first twist angle.

By thus varying the twist angle, the second preliminary flute can be formed such that creation of a step between the same and the first preliminary flute is prevented, while preventing the interference of the grinding stone with the first preliminary flute. That is, flutes having smooth inner surfaces are obtained. Accordingly, the risk of an ejection groove being caught in a step and having difficulty in ejection is eliminated.

Moreover, since electrical discharge machining is performed on the hard diamond layer, a grinding stone used for grinding work on the substrate and the body component is prevented from wearing down in a short period. Accordingly, the grinding stone can be used repeatedly when the second preliminary flute is formed on plural body components.

On the substrate and the body component, by contrast, grinding work is performed with a grinding stone. Thus, the second preliminary flute can be formed efficiently. Consequently, the efficiency of manufacture of a PCD drill is improved.

Preferably, an extreme tip of the second preliminary flute is located near a boundary between the diamond layer and the substrate. In this manner, it is possible to form a flute having large opening area and cross-sectional area, and facilitating the passage of cutting chips therethrough.

An electrode for performing the electrical discharge machining to form the first preliminary flute may be advanced from the diamond layer side to the substrate side, and then a grinding stone for performing the grinding work to form the second preliminary flute may be advanced from the body component side to the substrate side. This facilitates the formation of a first preliminary flute and a second preliminary flute having different twist angles from each other.

The grinding stone used for performing grinding work is desirably a diamond grinding stone because of its high hardness and resistance to wear.

In the present invention, the twist angle on the substrate and the body component is set larger than the twist angle on the diamond layer. Thus, the flute (the first preliminary flute) on the diamond layer and the flute (the second preliminary flute) on the substrate and the body component smoothly adjoin each other, preventing the creation of a step between them.

Accordingly, a situation where cutting chips have difficulty in ejection due to presence of a step is prevented, allowing cutting chips to easily pass through the flutes. Thus, the risk of cutting chips stopping in a flute and failing to be ejected is eliminated.

Besides, since the flute (the first preliminary flute) on the hard diamond layer is formed by electrical discharge machining, whereas flute (the second preliminary flute) on the substrate and the body component, which are relatively soft, is formed by grinding work, the flutes can be formed efficiently while preventing the grinding stone from wearing down in a short period. Thus, the efficiency of manufacture of a PCD drill is improved.

### BRIEF DESCRIPTION OF DRAWINGS

FIG. 1 is a general side view of a PCD drill according to an embodiment of the present invention in its entirety along a longitudinal direction;

FIG. 2 is a front view of a tip of the PCD drill shown in FIG. 1;

FIG. 3 is a side view of the tip of the PCD drill shown in FIG. 1;

FIG. 4 is a general perspective view showing a cylindrical member for producing a tip cutting tool as being cut from a wafer;

FIG. 5 is a general side view showing a state in which a V-groove is formed in the cylindrical member and a V-shaped end is formed on a round bar;

FIG. 6 is a general perspective view schematically showing a situation where thinning faces and the like are being formed by performing electrical discharge machining on the cylindrical member;

FIG. 7 is a general perspective view schematically showing a situation where a first preliminary flute, which will be made into a flute, is being formed by performing electrical discharge machining on the cylindrical member; and

FIG. 8 is a general perspective view schematically showing a situation where a second preliminary flute, which will be made into a flute, is being formed by applying grinding work to the round bar and a substrate.

### DESCRIPTION OF EMBODIMENTS

A manufacturing method for a PCD drill according to the present invention is described in detail below by showing a preferred embodiment thereof in relation to the resultant PCD drill and with reference to the accompanying drawings.

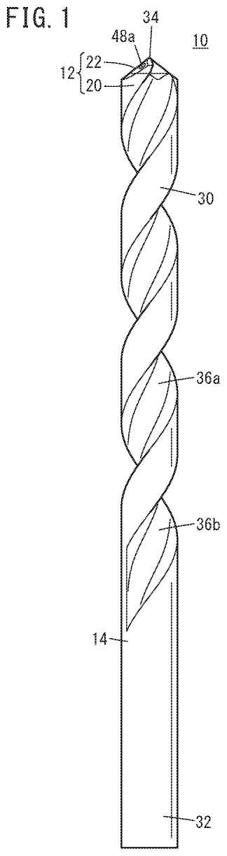

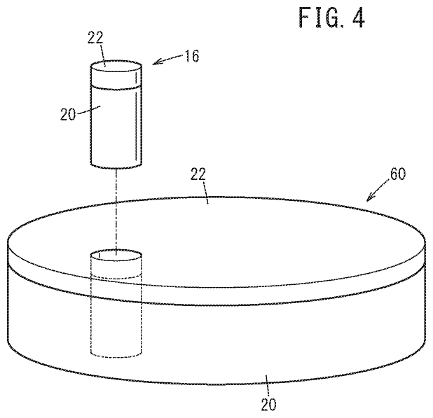

FIG. 1 is a general side view of a PCD drill 10 according to an embodiment in its entirety along the longitudinal direction. The PCD drill 10 includes a tip cutting tool 12 and an elongate body component 14. The tip cutting tool 12 is made by processing of a cylindrical member 16 shown in FIG. 4 into a geometry suited for the tip of a drill, and is composed of a substrate 20 and a sintered diamond layer (also denoted as “PCD layer” hereinafter) 22 as a diamond layer.

The substrate 20 is a disk-shaped member made of cemented carbide. Meanwhile, the PCD layer 22 is a disk-shaped member containing sintered polycrystalline diamond (PCD) and disposed so as to cover an end face of the substrate 20. The PCD layer 22 may be either a single-material layer made only of PCD or a composite material layer made from a composite of PCD and cemented carbide. The cemented carbide contained in the substrate 20 and the PCD layer 22 may be WC-Co and the like, by way of example. The ratio of PCD to cemented carbide may be set in the range of PCD:cemented carbide=90:10 to 10:90 in volume, for example.

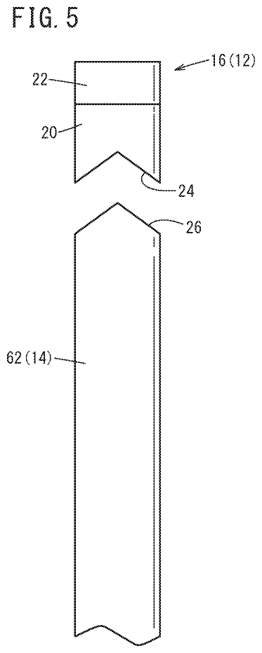

In the substrate 20, a V-groove 24 is formed as shown in FIG. 5. Correspondingly at a tip of the body component 14, a V-shaped end 26 conforming to the V-groove 24 is formed. The inner walls of the V-groove 24 and the inclined walls of the V-shaped end 26 are joined together by brazing, for example.

A large part of the body component 14 defines a body 30 together with the tip cutting tool 12, and one end of the body component 14, having a substantially cylindrical shape, defines a shank 32. In the body 30, two flutes 36a, 36b are formed so that they have a phase difference of about 180° across a chisel point 34. That is, the PCD drill 10 is a so-called twist drill. The flutes 36a, 36b, also called helical gashes, extend helically along the longitudinal direction of the body 30. The flutes 36a, 36b do not cross each other at any point.

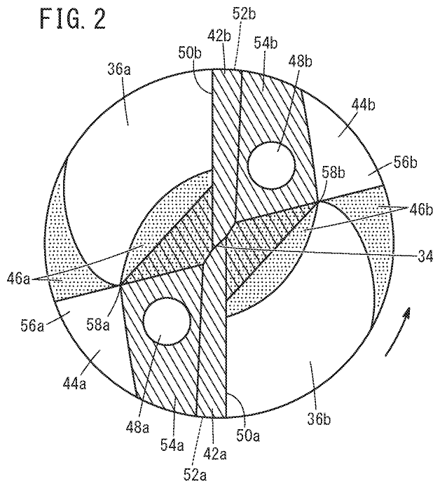

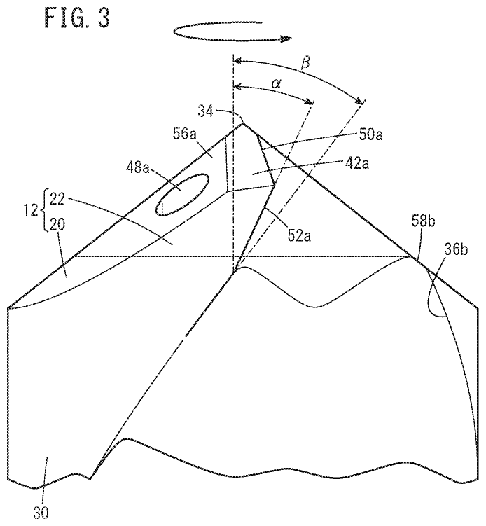

As shown in FIGS. 2 and 3, which are a front view and a side view of the tip of the PCD drill 10 respectively, first flanks 42a, 42b, second flanks 44a, 44b, and thinning faces 46a, 46b are formed on a tip surface defined by the tip cutting tool 12. In the second flanks 44a, 44b, leading holes 48a, 48b are bored, respectively, through which coolant agent such as cutting oil for exerting lubricating or cooling effect is directed. The leading holes 48a, 48b merge into a single guiding hole (not shown) bored in the shank 32. That is, during cutting work with the PCD drill 10, coolant agent divides into the two leading holes 48a, 48b via the guiding hole, and is supplied to the site of cutting work from the leading holes 48a, 48b.

A cutting edge 50a is formed on a ridge of the first flank 42a that faces the side of the flute 36b. As shown in FIG. 3, a rake face 52a adjoins the cutting edge 50a. In a similar manner, a cutting edge 50b is formed on a ridge of the first flank 42b that faces the side of the flute 36a, with a rake face 52b adjoining the cutting edge 50b.

The hatching in FIG. 2 indicates first regions 54a, 54b, in which the PCD layer 22 constituting the tip cutting tool 12 is exposed. The non-hatched regions are second regions 56a, 56b, in which cemented carbide is exposed. That is, the first regions 54a, 54b show the tip side including the chisel point 34, in other words, the top side, and the second regions 56a, 56b show the foot side. The hatching is given for convenience in order to facilitate the distinction between the first regions 54a, 54b and the second regions 56a, 56b.

An extreme tip 58a of the flute 36a is located near the boundary between the first region 54a and the second region 56a. Similarly, an extreme tip 58b of the flute 36b is located near the boundary between the first region 54b and the second region 56b.

As shown in FIG. 3, the twist angle of the flutes 36a, 36b on the body component 14 and the substrate 20, which are made of cemented carbide, is different from that in the PCD layer 22 mainly containing PCD. Specifically, a twist angle α on the PCD layer 22 is set smaller than a twist angle β in the part made of cemented carbide. That is, α<β holds. Further, the flutes 36a, 36b extend smoothly with no step formed therein.

Next, the manufacturing method for the PCD drill 10, which is basically configured as discussed above, is described.

To start with, as shown in FIG. 4, the cylindrical member 16 is cut out of a wafer 60 including cemented carbide as the substrate 20 and the PCD layer 22 formed on the substrate 20. The wafer 60 of this type is available as a commercial product. Since the cylindrical member 16 is a part which is cut out of the wafer 60, the cylindrical member 16 is certainly composed of the substrate 20 (cemented carbide) and the PCD layer 22.

Next, the V-groove 24 shown in FIG. 5 is formed on the substrate 20 side of this cylindrical member 16. At the same time, the V-shaped end 26 conforming to the V-groove 24 is formed in one end of a round bar 62 made of cemented carbide and the like. Then, the inner walls of the V-groove 24 are joined to the inclined walls of the V-shaped end 26 inserted in the V-groove 24 by, for example, brazing.

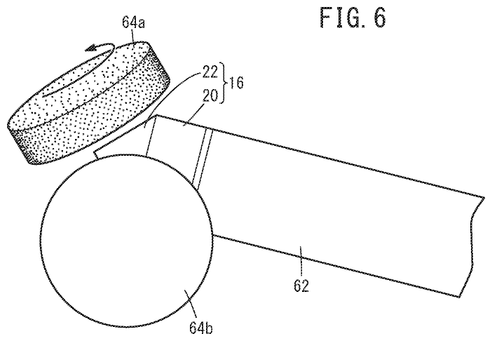

Next, as shown in FIG. 6, electrical discharge machining is performed using electrodes 64a, 64b. With this electrical discharge machining, the first flanks 42a, 42b, the second flanks 44a, 44b, the thinning faces 46a, 46b, the cutting edges 50a, 50b, and the rake faces 52a, 52b are formed on the cylindrical member 16. Further, the first regions 54a, 54b where the PCD layer 22 is exposed are formed and the second regions 56a, 56b where cemented carbide (the substrate 20) is exposed are formed.

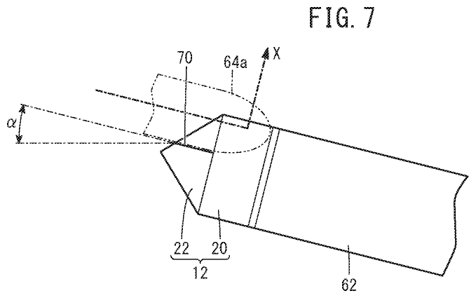

Next, as shown in FIG. 7, a first preliminary flute 70 is formed on the PCD layer 22 by performing electrical discharge machining with the electrode 64a. Here, the electrode 64a is moved from the PCD layer 22 side to the substrate 20 side as indicated by arrow X. During this process, the orientation of the electrode 64a is set such that the first twist angle will be α.

The movement of the electrode 64a is stopped immediately after the electrode 64a has reached the substrate 20. Thereafter, the electrode 64a is separated from the first preliminary flute 70.

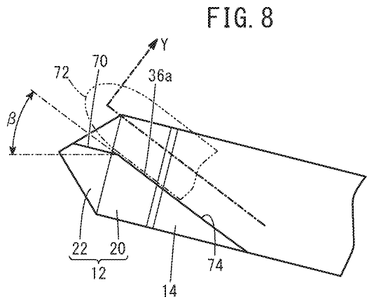

Next, as shown in FIG. 8, a second preliminary flute 74 is formed by performing grinding work with a diamond grinding stone 72. During this process, the diamond grinding stone 72 is moved from the round bar 62 (the body component 14) side to the substrate 20 side as indicated by arrow Y. Also, the orientation and direction of the diamond grinding stone 72 are set so that the second twist angle will be β, which is larger than α. Finally, the second preliminary flute 74 becomes adjoined to the first preliminary flute 70 to form a single flute 36a. The flute 36b is formed in a similar manner, thus producing the body 30.

As described, this embodiment forms the first preliminary flute 70 by performing electrical discharge machining on the PCD layer 22, which is hard. As a result, the diamond grinding stone 72 is prevented from wearing down in a short period, so that the diamond grinding stone 72 can be used repeatedly. That is, many rounds of grinding work can be carried out with the same diamond grinding stone 72.

By contrast, on the substrate 20 and the body component 14 (the round bar 62) made of a relatively soft material such as cemented carbide, the second preliminary flute 74 is formed by grinding work with the diamond grinding stone 72. Although the second preliminary flute 74 is longer than the first preliminary flute 70, grinding work can form the second preliminary flute 74 in a shorter time than electrical discharge machining. Accordingly, the flutes 36a, 36b can be formed efficiently.

Moreover, when performing the grinding work described above, this embodiment sets the second twist angle β so that it is larger than the first twist angle α. This prevents interference of the diamond grinding stone 72 with the PCD layer 22 during the grinding work on the substrate 20. Accordingly, the second preliminary flute 74 is easily formed on the substrate 20, and wear of the diamond grinding stone 72 resulting from grinding of the PCD layer 22 can be prevented as well.

Additionally, since the second twist angle β is larger than the first twist angle α, formation of a step between the first preliminary flute 70 and the second preliminary flute 74 is prevented. Thus, the flutes 36a, 36b with no step are obtained.

When cutting work is performed using such a PCD drill 10, cutting chips will easily pass through the flutes 36a, 36b to be ejected. Thus, the risk of cutting chips stopping in the flutes 36a, 36b is eliminated. This is because formation of steps in the flutes 36a, 36b is prevented as mentioned above.

The present invention is not intended to be limited to the above-descried embodiment but various modifications are possible without departing from the gist of the present invention.

For example, use of the diamond grinding stone 72 in the grinding work for forming the second preliminary flute 74 is not essential; the grinding work may be done with

What is claim is:

1. A polycrystalline diamond drill comprising a body component, and a tip cutting tool formed from a substrate made of cemented carbide and a diamond layer disposed on the substrate the tip cutting tool being set on a tip of the body component in a manner that the substrate faces the body component, thereby constituting a body,
wherein both the diamond layer and the cemented carbide are configured to be exposed on rake faces and thinning faces formed on the tip cutting tool, and
a first twist angle of the diamond layer is set smaller than a second twist angle of the substrate and the body component.

2. The polycrystalline diamond drill according to claim 1, wherein, on the thinning faces, an extreme tip of each of flutes is located near a boundary between the diamond layer and the substrate.

3. The polycrystalline diamond drill according to claim 1, wherein the body component is composed of cemented carbide.

4. The polycrystalline diamond drill according to claim 1, wherein either one of the tip cutting tool and the body component is provided with an engagement portion, and a remaining one of the tip cutting tool and the body component is provided with a mating engagement portion to be engaged with the engagement portion.

5. A manufacturing method for a polycrystalline diamond drill including a body component, and a tip cutting tool formed from a substrate made of cemented carbide and a diamond layer disposed on the substrate, the manufacturing method comprising:
a process of joining a cylindrical member which will be made into the tip cutting tool to a tip of the body component in a manner that the substrate faces the body component side;
a process of performing electrical discharge machining on the cylindrical member to form cutting edges and thinning faces, and to expose both the diamond layer and the substrate on rake faces and the thinning faces;
a process of performing electrical discharge machining on the diamond layer to form a first preliminary flute in a manner that the first preliminary flute is made at a first twist angle; and
a process of applying grinding work to the body component and the substrate to form a second preliminary flute in a manner that the second preliminary flute adjoins the first preliminary flute and is made at a second twist angle larger than the first twist angle.

6. The manufacturing method according to claim 5, wherein during formation of the second preliminary flute, an extreme tip of the second preliminary flute is located near a boundary between the diamond layer and the substrate.

7. The manufacturing method according to claim 5, wherein an electrode for performing the electrical discharge machining to form the first preliminary flute is advanced from the diamond layer side to the substrate side, and then a grinding stone for performing the grinding work to form the second preliminary flute is advanced from the body component side to the substrate side.

8. The manufacturing method according to claim 5, wherein the grinding work is performed using a diamond grinding stone.

9. The manufacturing method according to claim 5, wherein either one of the tip cutting tool and the body component is provided with an engagement portion, a remaining one of the tip cutting tool and the body component is provided with a mating engagement portion to be engaged with the engagement portion, and the tip cutting tool is joined to the body component with the engagement portion engaged with the mating engagement portion.
